(19) United States
(12) Patent Application Publication
(10) Pub. No.: US 2014/0226188 A1
(43) Pub. Date: Aug. 14, 2014

(54) IMAGE RECOMBINATION STRUCTURE

(71) Applicant: Industrial Technology Research Institute, Hsinchu (TW)

(72) Inventors: Chang-Shuo WU, New Taipei City (TW); Wu-Li CHEN, Taipei City (TW); Chao-Hsu TSAI, Hsinchu City (TW)

(73) Assignee: Industrial Technology Research Institute, Hsinchu (TW)

(21) Appl. No.: 13/964,609

(22) Filed: Aug. 12, 2013

(30) Foreign Application Priority Data
Feb. 8, 2013 (TW) 102105335

(51) Int. Cl. H04N 1/409

(52) U.S. Cl. CPC H04N 1/409
USPC 358/3.26

(57) ABSTRACT

An image recombination structure is disclosed. The structure includes a plurality of image information layers and an optical element layer. The image information layers are laminated or overlapped to each other in a projecting direction of a light and are combined into an image. At least two image information of the image are formed on the image information layers respectively according to a color information and a lightness information of the image or according to a color model of the image to display the image by means of superposition. The optical element layer and the image information layers are overlapped in the projecting direction of the light.

This application claims the benefit of Taiwan application Serial No. 102105335, filed Feb. 8, 2013, the disclosure of which is incorporated by reference herein in its entirety.

### TECHNICAL FIELD

The disclosure relates in general to an image formation structure, and more particularly to an image recombination structure.

### BACKGROUND

Normally, an image is formed by the inject printing method, the laser printing method or the screen printing method, in which the ink is printed or imprinted on the printed material. However, there are some problems in the above methods. For example, the ink printed may spread or diffuse after the ink was dispensed on the printed point. Furthermore, if the pitches of the printed points are too small, the area of the ink overlapped between adjacent printed points may increase, not only increasing the crosstalk area of the image but also deteriorating image resolution.

Particularly, in the formation of a 3D image, if the images viewed by the left eye and the right eye are not completely separated, the image supposed to be viewed by the left eye may be viewed by the right eye, and vice versa. Consequently, crosstalk phenomenon may lead to the images viewed by the left eye and the right eye and synthesized in the viewer's brain to form a 3D image with crosstalk, and thus cannot provide 3D visual effect. Also, when the 3D image is viewed from different angles, the resolution of the 3D image at large view angle is poor due to the limited fields of vision.

### SUMMARY

The disclosure is directed to an image recombination structure having an increased image resolution and an increased number of fields of vision at different view angles.

According to one embodiment, an image recombination structure is disclosed. The structure comprises a plurality of image information layers and an optical element layer. The image information layers are laminated or overlapped to each other in a projecting direction of a light and are combined into an image. At least two image information of the image are formed on the image information layers respectively according to a color information and a lightness information of the image or a color model of the image to display the image by means of superposition. The optical element layer and the image information layers are overlapped in the projecting direction of the light.

According to another embodiment, an image recombination structure is disclosed. The structure comprises a plurality of image information layers and a light source array module. The image information layers are laminated or overlapped to each other in a projecting direction of a light and combined into an image. At least two image information of the image are formed on the image information layers respectively according to a color information and a lightness information of the image or a color model of the image to display the image by means of superposition. The light source array module and the image information layers are overlapped in the projecting direction of the light.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIGS. 1A and 1B respectively show an image display model.

FIGS. 2A and 2B respectively show a schematic diagram of an image recombination structure according to an embodiment of the disclosure.

FIGS. 3A and 3B respectively show a schematic diagram of an image recombination structure according to another embodiment of the disclosure.

FIGS. 4A and 4B respectively show a schematic diagram of an image recombination structure according to an alternate embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

According to the image recombination structure of the present embodiment, different image information are delaminated in different layers and disposed through a combination of two or more image information layers, such that at least two image information of the image are formed on the image information layers respectively to display the image by means of superposition to improve the crosstalk of the image. In general, the human eyes are sensitive to the value (lightness) of the image, and are less sensitive to the hue, saturation, color or chromaticity of the image. If only one image layer is used, the human eyes will have only one sensitivity to the value and color on the same image layer. Once the crosstalk phenomenon occurs to the image, the human eyes will not be able to improve image resolution according to their high sensitivity to the value (lightness).

If the hue layer and the lightness layer are delaminated, the human eyes will have different sensitivities towards the value and hue of different image information layers. Therefore, image crosstalk is determined according to the sum of the ratio of the sensitivity of the human eyes towards each image information layer. That is, if the human eyes are more sensitive to the value, then crosstalk is mainly caused by the resolution of the lightness layer. In other words, the crosstalk caused by the hue layer occupies a relatively smaller ratio. In the present embodiment, according to high sensitivity of human eyes to the value, the resolution of human eyes to the image can be improved.

To realize the concept of image recombination from the disclosure, the lightness layer represents the lightness of the image through the degree of gray level by using a non-printing (such as marking or engraving) method. In comparison to the hue layer formed by using the inject printing or imprinting method, the lightness layer formed by using the non-printing method controls the pitch and diffusion between the value points to be within a predetermined range, not only avoiding the ink being spread or diffused in the printed point, but also increasing the resolution of the lightness layer and reduce the crosstalk area.

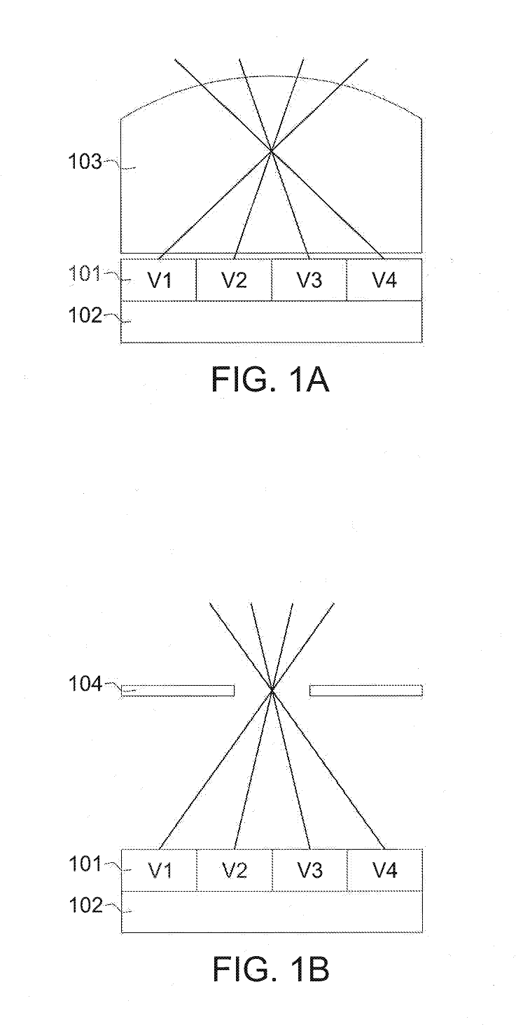

Particularly, the concept of recombination of the disclosure can be used in the display of 2D or 3D image. Referring to FIGS. 1A and 1B, image display models are shown respectively. The image information is separated into a lightness layer 101 and a hue layer 102. Since the human eyes are highly sensitive to the lightness of the image, the crosstalk phenomenon occurring when the human eyes are watching a 3D image is mainly based on the resolution of the lightness layer 101. As long as the resolution of the lightness layer 101 is high enough, the images V1˜V4 at different fields of vision can be displayed at different view angles to produce a better 3D visual effect when the images V1˜V4 are imaged by the lens 103 (or the cylindrical lens) or separated by the barrier 104. Furthermore, when the images are viewed from different angles or by moving viewer's position, a 3D image with a large view angle and smooth change can be displayed due to the increase in the number of fields of vision of the lightness layer 101.

A number of embodiments are disclosed below for elaborating the invention. However, the embodiments of the disclosure are for detailed descriptions only, not for limiting the scope of protection of the invention.

The embodiments disclosed below are not limited to separating image information into a lightness layer and a hue layer. For example, the image information can be separated according to a color model of a color space of the image, such as the red/green/blue (RGB) color model, the cyan/magenta/yellow/black (CMYK) color model or the hue/saturation/value (HSV) color model.

### First Embodiment

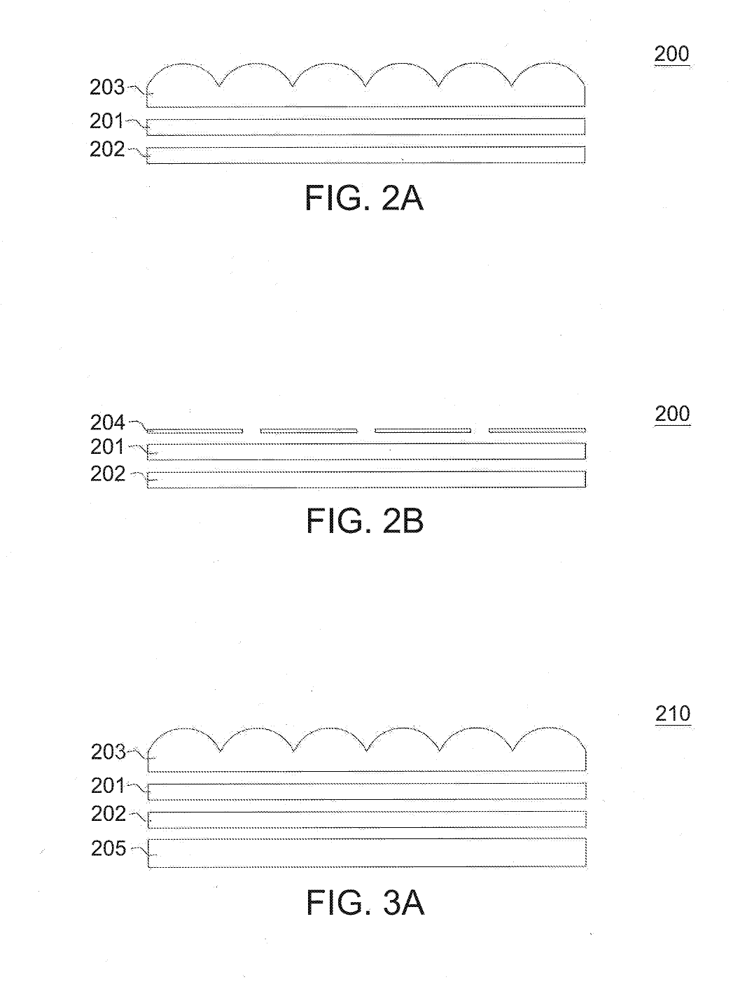

Referring or FIGS. 2A and 2B, schematic diagrams of an image recombination structure 200 according to an embodiment of the disclosure are shown. The image recombination structure 200 comprises a plurality of image information layers 201 and 202 and an optical element layer 203 or 204. The image information layers 201 and 202 are laminated or overlapped to each other in a projecting direction of a light (such as a back light or ambient light) and are combined into an image. For example, two or more than two image information layers are combined into a 2D or 3D image, and then the image is displayed by means of superposition.

The optical element layer 203 or 204 and the image information layers 201 and 202 are overlapped in the projecting direction of the light. The optical element layer is a 1D or a 2D parallax optical element. The 1D parallax optical element is such as a lenticular lens or a barrier (grating), and the 2D parallax optical element is such as a lens array unit or a pin hole array unit. As indicated in FIG. 2A, the optical element layer 203 is such as a lenticular lens unit or a lens array unit. As indicated in FIG. 2B, the optical element layer 204 is such as a barrier or a pin hole array unit. In FIG. 2B, the optical element layer 204 and the image information layer 201 are overlapped in the projecting direction of the light such that the optical element layer 204 and the image information layer 201 can abut to each other from up to down or can be adjacently disposed without abutting to each other. For example, a substrate (not illustrated), such as a PC (polycarbonate) board or a glass board, can be interposed between the optical element layer 204 and the image information layers 201 for controlling the distance of viewing the 3D image.

As indicated in FIGS. 1A and 1B, the images V1˜V4 at different fields of visions can be displayed at different view angle through the processing of the optical element layer 203 or 204 to produce a 3D visual effect.

Based on the concept of image recombination of the disclosure, image information can be separated into a hue layer and a lightness layer according to the color information and the lightness information of the image, separated into two layers or three layers according to a color space defined by the RGB image, separated into two layers, three layers or four layers according to a color space defined by the CMYK image, or separated into two layers or three layers according to a color space defined by the hue/saturation/value (HSV) of the image.

By means of image recombination, as long as the human eyes are more sensitive to one of the delaminated image information layers 201 and 202, image resolution can be improved through the human eyes' high sensitivity to one of the image information layers 201 and 202.

The image information layers 201 and 202 are exchangeable with each other from top layer to bottom layer. The present embodiment can be implemented no matter the image information layer 201 is disposed above or under the image information layer 202.

### Second Embodiment

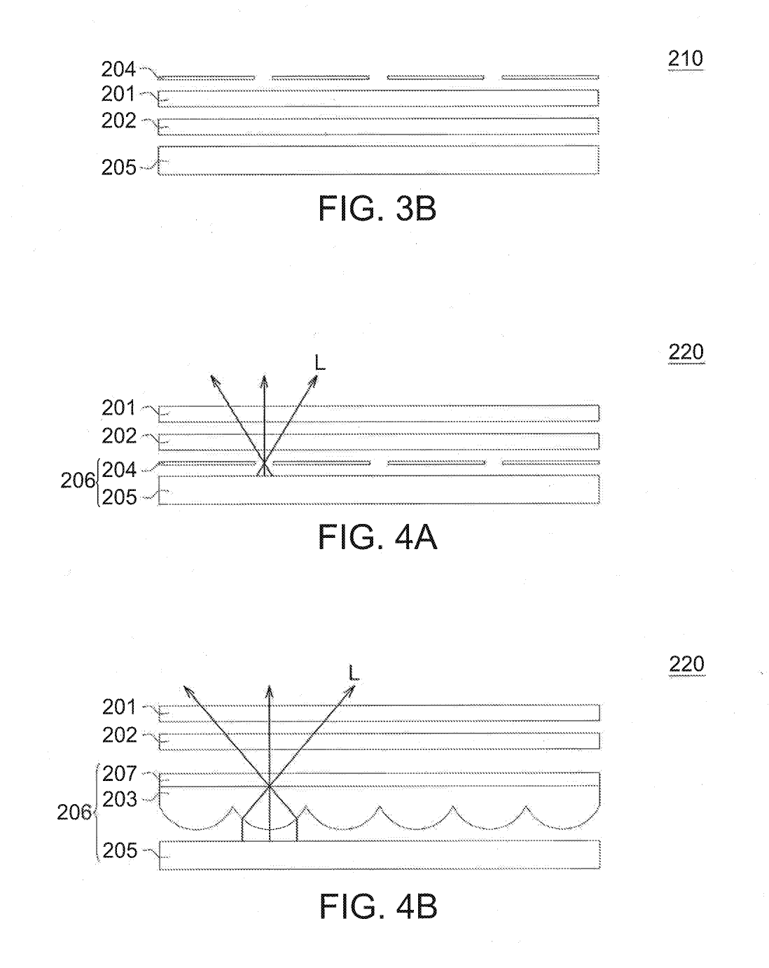

Referring to FIGS. 3A and 3B, schematic diagrams of an image recombination structure 210 according to another embodiment of the disclosure are shown. The image recombination structure 210 comprises a plurality of image information layers 201 and 202, an optical element layer 203 and a light source 205. The image information layers 201 and 202 are laminated or overlapped to each other in a projecting direction of a light and are combined into an image. For example, two or more than two image information layers are combined into a 2D or 3D image, and then the image is displayed by means of superposition. In addition, the optical element layer 203 or 204 and the image information layers 201 and 202 are overlapped in the projecting direction of the light.

The recombination of the image information layers 201 and 202, the color model of the color space and the type of the optical element layer 203 or 204 are disclosed in the first embodiment and are not repeated in the present embodiment.

The present embodiment is different from the first embodiment in that: the image information layers 201 and 202 of the first embodiment uses an ambient light to display the image, while the image information layers 201 and 202 of the present embodiment, use a directional light source or an ordinary light source (an omni-directional light source) 205 to display the image. In the first embodiment, the backlight source may not be needed if the ambient light has a sufficient strength.

As indicated in FIGS. 3A and 3B, the optical element layer 203 or 204 is disposed above the image information layers 201 and 202, and the light source 205 is disposed under the image information layers 201 and 202 and used as a light source such as a white light source. The image information layers 201 and 202 are disposed between light source 205 and the optical element layer 203 or 204. The light firstly passes through the image information layers 201 and 202 to represent the hue and lightness of the image and then displays the image through the processing of the optical element layer 203 or 204.

### Third Embodiment

Referring or FIGS. 4A and 4B, schematic diagrams of an image recombination structure 220 according to another embodiment of the disclosure are shown. The image recombination structure 220 comprises a plurality of image information layers 201 and 202, an optical element layer 203 or 204 and a light source 205. The image information layers 201 and 202 are laminated or overlapped in a projecting direction of a light and are combined into an image. For example, two or more than two image information layers are combined into a 2D or 3D image, and then the image is displayed by means of superposition. In addition, the optical element layer 203 or 204 and the image information layers 201 and 202 are overlapped in the projecting direction of the light.

The recombination of the image information layers 201 and 202, the color model of the color space and the type of the optical element layer 203 or 204 are disclosed in the first embodiment and are not repeated in the present embodiment.

The present embodiment is different from the second embodiment in that: the optical element layer 203 or 204 and the light source 205 of the second embodiment are respectively disposed on two opposite sides of the image information layers 201 and 202, while the optical element layer 203 or 204 and the light source 205 of the present embodiment are disposed on the same side of the image information layers 201 and 202 to form a light source array module 206. In FIG. 4A, the light source 205 can be an omni-directional light source, such as a fluorescent lamp. In FIG. 4B, the light source 205 can be a directional light source such as a semiconductor light emitting element (light emitting diode).

The light source array module 206, such as a parallel-strip type light source array module or a point light source array module, provides a parallel-strip light source or a point light source.

As indicated in FIGS. 4A and 4B, the optical element layer 203 or 204 is disposed between the image information layers 201 and 202 and light source 205. Through the processing of the optical element layer 203, the light source 205 becomes a parallel-strip light source or a point light source, the light L emitted from the light source 205 then passes through the image information layers 201 and 202 to display the hue and lightness of the image.

Referring to FIG. 4B, the light source array module 206 further comprises a diffuser 207 abutting to the optical element layer 203. The diffuser 207 and the optical element layer 203 are overlapped in a projecting direction of a light for increasing the divergence angle of the light. The diffuser can be used as a lightness enhancer, a prism or an optical film capable of diffusing the light and increasing the lightness of the light. In FIG. 4A, the optical element layer 204 and the image information layer 202 are overlapped in the projecting direction of the light such that the optical element layer 204 and the image information layer 202 can abut to each other from up to down or can be adjacently disposed without abutting to each other.

In the image recombination structure disclosed in above embodiments of the disclosure, image information are separated into at least two image information layers to which provide the human eyes have different sensitivities, hence improving the situation of the conventional single-layered image layer which provides only one sensitivity to the human eyes. By means of image recombination, crosstalk phenomenon is not determined by one single-layered image layer but by the layer with lowest crosstalk among a plurality of image information layers, that is, the layer with highest resolution.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image recombination structure, comprising:
a plurality of image information layers laminated or overlapped to each other in a projecting direction of a light and combined into an image, wherein at least two image information of the image are formed on the image information layers respectively according to a color information and a lightness information of the image or according to a color model of a color space of the image to display the image by means of superposition: and
an optical element layer, wherein the optical element layer and the image information layers are overlapped in the projecting direction of the light.

2. The image recombination structure according to claim 1, wherein the optical element layer is a barrier or a pin hole array unit.

3. The image recombination structure according to claim 1, wherein the optical element layer is a lenticular lens unit or a lens array unit.

4. The image recombination structure according to claim 3, further comprising a diffuser, wherein the diffuser and the optical element layer are overlapped in the projecting direction of the light.

5. The image recombination structure according to claim 1, wherein the image information layers use an ambient light to display the image.

6. The image recombination structure according to claim 1, wherein the color model comprises a red/green/blue (RGB) color model, a cyan/magenta/yellow/black (CMYK) color model or a hue/saturation/value (HSV) color model.

7. The image recombination structure according to claim 1, wherein the image information layers are separated into a hue layer and a lightness layer according to the color information and the lightness information of the image.

8. An image recombination structure, comprising:
a plurality of image information layers laminated or overlapped to each other in a projecting direction of a light and combined into an image, wherein at least two image information of the image are formed on the image information layers respectively according to a color information and a lightness information of the image or according to a color model of the image to display the image by means of superposition: and a light source array module, the light source array module and the image information layers are overlapped in the projecting direction of the light.

9. The image recombination structure according to claim 8, wherein the light source array module is a parallel-strip type light source array module or a point light source array module.

10. The image recombination structure according to claim 8, wherein the light source array module is composed of a light source and an optical element layer, and the light source is an omni-directional light source or a directional light source.

11. The image recombination structure according to claim 10, wherein the image information layers are disposed between the light source and the optical element layer.

12. The image recombination structure according to claim 10, wherein the optical element layer is disposed between the light source and the image information layers.

13. The image recombination structure according to claim 10, wherein the optical element layer is a barrier or a pin hole array unit.

14. The image recombination structure according to claim 10, wherein the optical element layer is a lenticular lens unit or a lens array unit.

15. The image recombination structure according to claim 14, further comprising a diffuser, wherein the diffuser and the optical element layer are overlapped in the projecting direction of the light.

16. The image recombination structure according to claim 8, wherein the color model comprises a red/green/blue (RGB) color model, a cyan/magenta/yellow/black (CMYK) color model or a hue/saturation/value (HSV) color model.

17. The image recombination structure according to claim 8, wherein the image information layers are separated into a hue layer and a lightness layer according to the color information and the lightness information of the image.
